(19) United States
(12) Patent Application Publication
(10) Pub. No.: US 2011/0023312 A1
(43) Pub. Date: Feb. 3, 2011

(54) Digital scale: A Digital measuring device for contruction and technical drawings

(76) Inventor: Chris Lewis Turner, Murfreesboro, TN (US)

Correspondence Address: Chris Lewis Turner, 3522 Salem Cove Lane, Murfreesboro, TN, 37128, US

(21) Appl. No.: 12/804,851

(22) Filed: Jul. 30, 2010

Related U.S. Application Data
(60) Provisional application No. 61/230,399, filed on Jul. 31, 2009.

(51) Int. Cl. B43L 7/00

(52) U.S. Cl. 33/494

(57) ABSTRACT

The digital scale is an improved, digital measuring device for all aspects of construction and construction estimating. Every scale used for construction today is included in this digital device. Instead of requiring several different scales for all types of engineering and architectural projects, with this device, one scale is all that is needed. This device also includes the capability to measure every part of a construction roof. All rafters, including hips, valleys, common and mixed pitch valley and hip rafters can be easily measured by simply setting this device on the drawings themselves. Square footage of the roof area for figuring roof felt, roof decking, shingles, and nails is quick and easy with this tool. Whether the rafters are being measured from the bird's eye view (top of roof) or the elevation views (all 4 sides), this device is accurate within 0.032″.

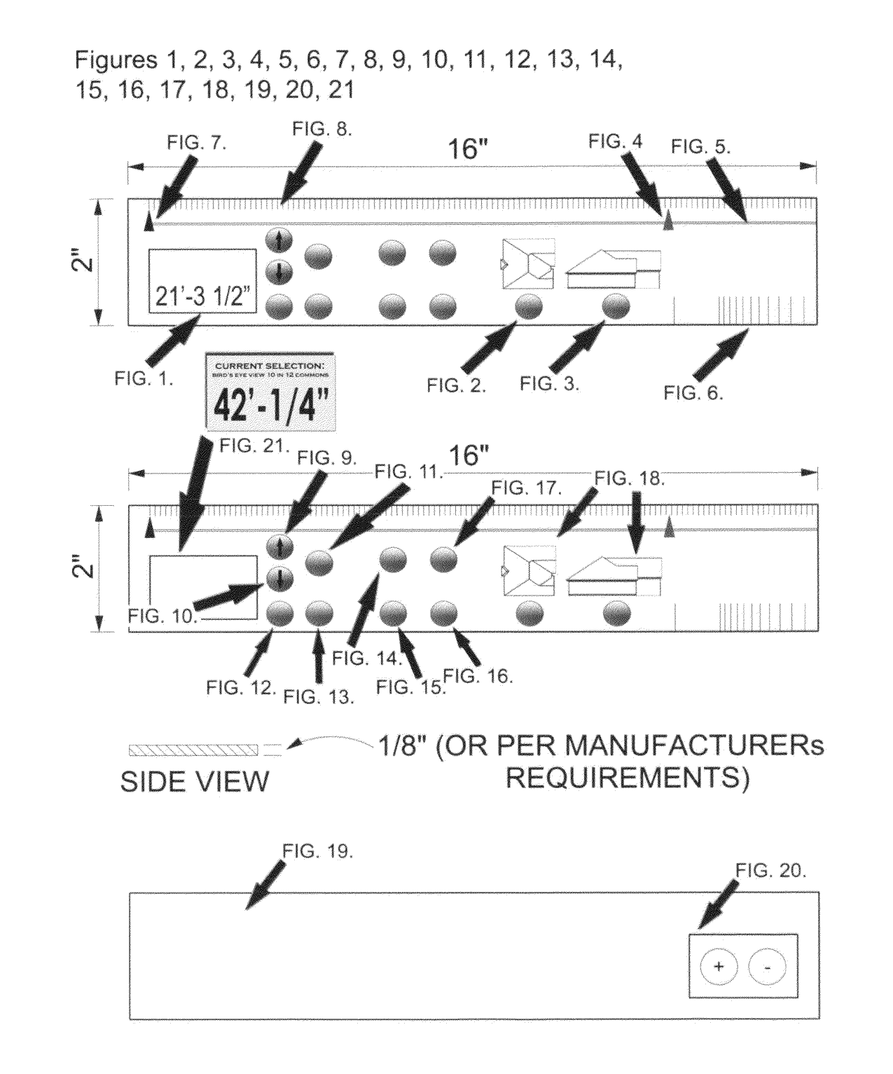

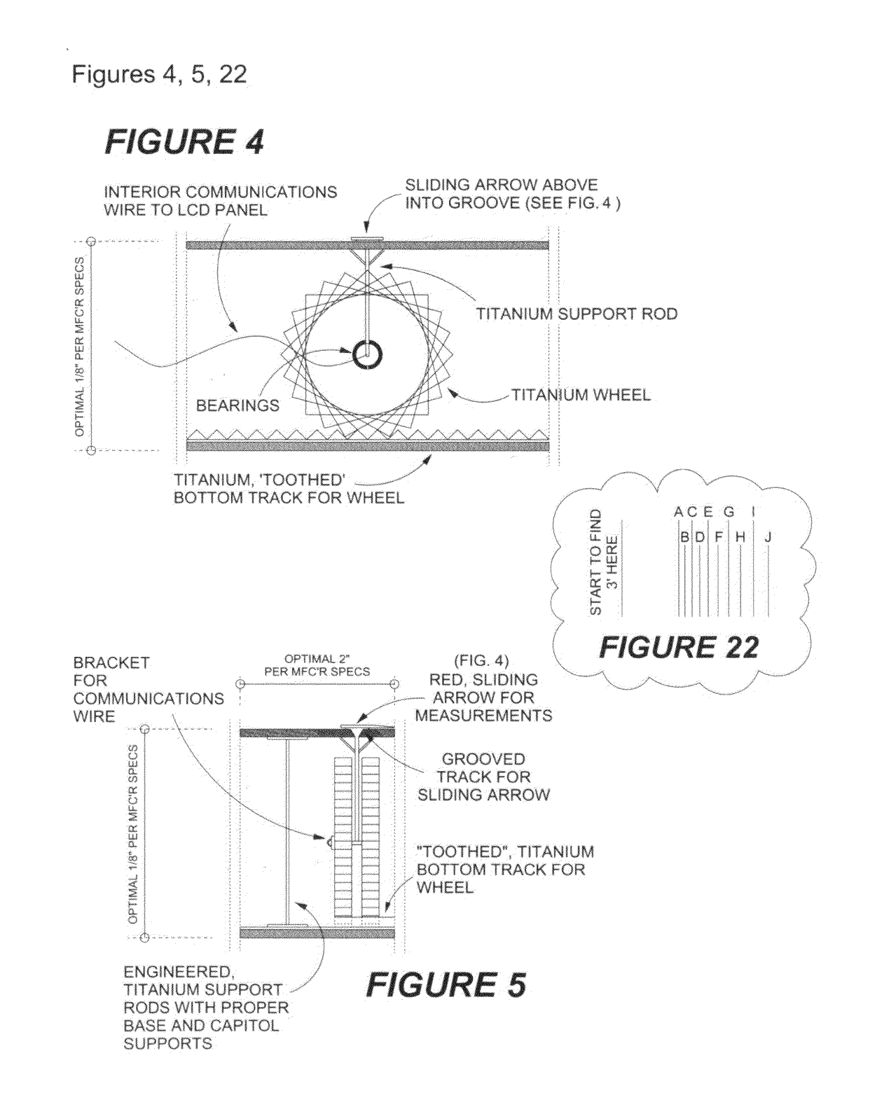

This patent application claims benefit to Provisional Patent Application #61230399, originally titled ‘Digital Scale’.

### BRIEF SUMMARY OF THE INVENTION

The Digital Scale is a digital measuring device used for measuring architectural and engineering drawings. It has a menu of selection options that when the desired scale is selected, a pre-calculated image will display on an LCD panel. That panel will be laid on the drawings just like a regular triangle plastic scale, and the drawings can be measured from the LCD panel and the image that is selected and displayed. From floor plans to engineering technical drawings such as site plans, commercial structures, and mechanical drawings, the digital scale eliminates all of the existing plastic triangle scales. Also, this device includes all pre-determined rafter calculations so that any rafter length can be measured on a set of architectural or engineering drawings. The rafters can be determined from the bird's eye view (the top of the roof), or the elevation views of the 4 (four) complete sides of the home or structure. All rafters are included such as hip and valley rafters, even pitched common rafters and combined pitch hip and valley rafters. This device also includes 10 notches at the bottom of increments of 0.10″; each notch is labeled A through J. And set 0.10″ down from 3′-0″ at ¼″=1′-0″. If a set of drawings is not to scale, the user will simply locate an item that is 3′ on their drawings. This is most commonly a door or a window. The user will then line that known 3′ up with the notches on the device, select the corresponding letter and the entire scale will convert down or up to that specific scale required.

Architectural Scales (measurements) included are: These have been converted into a digital format.

3/32″=1′-0″, ⅛″=1′-0″, ¼″=1′-0″ 3/16″=1′-0″, ⅜″=1′-0″, ½″=1′-0″, ¾″=1′-0″, 1″=1′-0″, 1½″=1′-0″, 3″=1′-0″ and 16″ on center markings.

Engineers scales (measurements) included are: These have been converted into a digital format.

1″=10′, 1″=20′, 1″=30′, 1″=40′, 1″=50′, 1″=60′

Rafter Scales included are: These have been converted into a digital format.

### Uneven Roof Pitch Hip and Valley Rafters for Bird's Eye Views

2 pitch combined with 3″ through 16″
3 pitch combined with 2″ through 16″
4 pitch combined with 2″ through 16″
5 pitch combined with 2″ through 16″
6 pitch combined with 2″ through 16″
7 pitch combined with 2″ through 16″
8 pitch combined with 2″ through 16″
9 pitch combined with 2″ through 16″
10 pitch combined with 2″ through 16″
11 pitch combined with 2″ through 16″
12 pitch combined with 2″ through 16″
13 pitch combined with 2″ through 16″
14 pitch combined with 2″ through 16″
15 pitch combined with 2″ through 16″
16 pitch combined with 2″ through 15″

### Uneven Roof Pitch Hip and Valley Rafters for Elevation Views

2 pitch combined with 3″ through 16″
3 pitch combined with 2″ through 16″
4 pitch combined with 2″ through 16″
5 pitch combined with 2″ through 16″
6 pitch combined with 2″ through 16″
7 pitch combined with 2″ through 16″
8 pitch combined with 2″ through 16″
9 pitch combined with 2″ through 16″
10 pitch combined with 2″ through 16″
11 pitch combined with 2″ through 16″
12 pitch combined with 2″ through 16″
13 pitch combined with 2″ through 16″
14 pitch combined with 2″ through 16″
15 pitch combined with 2″ through 16″
16 pitch combined with 2″ through 15″

### Even Roof Pitch Common Rafters for Bird's Eye Views

2 and 12, 3 and 12, 4 and 12, 5 and 12, 6 and 12, 7 and 12, 8 and 12, 9 and 12, 10 and 12, 11 and 12, 13 and 12, 14 and 12, 15 and 12, 16 and 12

### Even Roof Pitch Common Rafters for Elevation Views

2 and 12, 3 and 12, 4 and 12, 5 and 12, 6 and 12, 7 and 12, 8 and 12, 9 and 12, 10 and 12, 11 and 12, 13 and 12, 14 and 12, 15 and 12, 16 and 12

Even Roof Pitch Hip and Valley Rafters for Bird's Eye Views

2 and 12, 3 and 12, 4 and 12, 5 and 12, 6 and 12, 7 and 12, 8 and 12, 9 and 12, 10 and 12, 11 and 12, 13 and 12, 14 and 12, 15 and 12, 16 and 12

### Even Roof Pitch Hip and Valley Rafters for Elevation Views

2 and 12, 3 and 12, 4 and 12, 5 and 12, 6 and 12, 7 and 12, 8 and 12, 9 and 12, 10 and 12, 11 and 12, 13 and 12, 14 and 12, 15 and 12, 16 and 12

Not to scale 0.10″ increment calculations down from 3′-0″ at ¼″=1′-0″ of 10 sets of each of the above items. (shown in Diagram #1)

### DESCRIPTIONS OF ATTACHED DRAWINGS

### Diagram 1

This shows the prospected style and technical aspects of the device. It is proposed to be made of high impact plastic with an LCD panel that measures 1½″ tall×16″ wide. It will have a power button, a menu button, and two scroll buttons to scroll up and down though the menu. There will also have to be a select button provided for the user. The reveal on the bottom of the device will be as minimum as allowed by the LCD supplier as this is the side of the scale that is laid on the drawings for measuring. It is planned that the height will be 2⅛″ to 2¼″, the top portion should be ¼″, the bottom should be 2⅝″ to 2¾″, and the front (which is the face or hypotenuse) should be 3″. It will hold a power supply such as a “AA” or 9 volt battery, whichever is needed. It will have a computer chip which will be programmed with the necessary programming to make the device run as described in the descriptions and specifications.

### Diagram 2A

This shows how the portion of the device is used to measure rafters, commons and hips and valleys, from a bird's eye view (top view). The user will simply select the proper pitch and scale that the documents require, and lay the LCD panel with the proper selection displayed, and obtain a rafter length. The measurements are obtained from starting at the end points of the rafters.

### Diagram 2B

This shows how the portion of the device is used to measure rafters, commons and hips and valleys, from an Elevation View. The user will simply select the proper pitch and scale that the documents require, and lay the LCD panel with the proper selection displayed, and obtain a rafter length. These measurements are obtained by starting at the ridge (top of roof) and ending at the bottom of the fascia board.

### Diagram 2C

This shows how the portion of the device is used to measure engineered plans. Usually consisting of site plans and landscaping documents. The user will simply select the proper scale that the documents require, and lay the LCD panel with the proper selection displayed, and obtain any desired measurement from the plans.

### Diagram 2D

This shows how the portion of the device is used to measure and mark 16″ centers on a set of plans. Usually used for plans that do not show the individual rafters on the drawings, but do show a bird's eye view (top view). This is for marking rafters at every 16″ on center. Rafters in residential design are set and framed in every 16″. Most plans do not show the actual rafters, so this portion of the device will aid in that placement.

### Diagram 2E

This shows how to use the digital scale to measure construction document floor plans. This will aid in the estimator's calculations in determining material figures and job costs. It will also help to obtain measurements that may be excluded by human error by the designer or architect. Measurements can easily be obtained from one side of the drawings to the other, skipping several un-needed numbers in the process.

### Diagram 3

This diagram shows one set of bars for one (1) pitch set of rafters at all of the possible scales. Only one of the ‘scales’ will be displayed when selected. This diagram is just to show what will actually be displayed on the LCD screen.

### BACKGROUND OF THE INVENTION

I currently hold a Bachelor's Degree in Construction Technology from Middle Tennessee State University. My last semester in college, I worked for a lumber company as an outside sales associate, which entailed duties of floor plan estimations. These estimations were the actual material quantity list that the jobs would require for construction. When it came to estimating the amount and length of the rafters required, I would have to input into a calculator, whether that be a construction calculator or enter the multiplying factor for a particular rafter or set of rafters. This required taking the span (which is the bottom chord) adding 12″ for the overhang, finding the pitch, and multiplying that length by the pitch factor to get my whole rafter length.

This was for regular common rafters. When it came to hip and valley rafters, the same procedure was followed, except the multiplying factor was from a separate chart.

These rafter length calculations can also be obtained from a span chart in a book. This requires finding the bottom chord length of the desired rafter or set of rafters, looking in the book for the rafter length chart, and locating the proper length of that rafter.

After college, I started a Residential Design firm on my own. I have been in business for almost 15 (fifteen) years. In 1998, I passed the National Council of Building Designers exam. I currently design homes and light commercial projects for construction. In designing my structures, I have to know, and be aware of, every structural aspect of the building. Some designers would say that the roof is the most difficult part to design, so I made it my mission to make it one of the easiest. I started thinking in ways to help the local estimators who actually figure the materials that will be sent out to the jobs. So I began to work on a device to aid in the estimation of the roof system. I thought, instead of looking in a book, or having to have a calculator, what if you could just simply lay a device down on the drawings and obtain rafter lengths?

I began to work on all of the calculations that were needed to obtain a rafter length from every possible point on a set of drawings. When those calculations were finished, I had obtained so many scales that it was impossible to have just a three or four sided device, so digital was my only option. This allowed me to include all of the existing scales ie: architectural and engineering to be implemented into my work. I began to search for a programmer to aid in the programming. When that was accomplished, I began to search for a way to produce this digital device.

With the exception of a few design issues, the calculations, methods and charts are complete and ready to patent.

### DETAILED DESCRIPTION OF INVENTION

The current and only way to obtain rafter lengths from a set of drawings is to locate the span point of a rafter or a set of rafters. Determine the bottom chord length, which is % the total span length, add 12″, or required, for the overhang, determine the roof pitch, take the run (chord length) and multiply that number by the pitch factor. This would give ONE rafter length. To find the ‘Jack Rafters’, which is the remaining rafters down the hip ridge line, separate calculations must be input. Another way is to look in a book with a chart that determines rafter lengths based upon the pitch vs. the chord length (nm). Another way is to use a type of calculator that determines rafter lengths based upon the rise vs. run. This requires users to input the bottom chord length (nm), add for the overhangs, and select the proper pitch. These calculators will also obtain ‘jack’ rafters, which are the smaller consecutive rafters going down a hip ridge. The user will have to recalculate for each and every jack rafter at this point. The hip and valley rafters are figured on these calculators in a similar manner. These are a lot of steps involved for obtaining rafter lengths on a set of drawings. Plus, for different scales that are required for different drawings, a totally different scale is needed.

When material estimations are being done on a set of floor plans, this requires the current plastic scales that only have limited scales included. If there is a set of drawings obtained that are not to scale, the estimator will have to add the numbers on a calculator, and hope that the numbers are correct.

Currently, on the market, there is a device that is digital for completing take-offs for construction documents. This is a ‘roller’ device with a small rolling wheel that is placed on the plans and rolled from one point to the next. Through my research, the problem that users have with this device is when picking up the wheel off of the prints, it keeps rolling and therefore measuring when nothing is there. Also, it is very difficult to roll it in a straight line on the plans, so an accurate dimension cannot be achieved. This device does have a custom scale input, but it does not come with a way to figure the length of rafters or the components of a roof on a structure. The roof section of our ‘Digital Scale’ is the main part of our device.

For engineering drawings, the same applications apply.

The Digital Scale: A Digital Measuring Device For Construction Documents, eliminates all of the input calculations that are needed in the current way of estimating and measuring construction documents. This device can simply be laid upon a set of construction documents to find any desired rafter length at any given roof pitch at any given drawing scale. It also aids in the estimation and measuring of floor plans, technical, and engineering drawings.

It has a menu button to allow the user to scroll through and select the proper scale for their specific project. (Diagram 1) When the desired scale is chosen, a pre-calculated image will display on an LCD panel. (Diagram 1) That panel will be laid on the drawings just like a regular triangle plastic scale, and the drawings can be measured from the LCD panel and the image that is selected and displayed. From floor plans (Diagram 2E) to engineering technical drawings such as site plans, commercial structures, and mechanical drawings, the digital scale eliminates all of the existing plastic triangle scales. (Diagram 2C) Also, this device includes all pre-determined rafter calculations so that any rafter length can be measured on a set of architectural or engineering drawings. The rafters can be determined from the bird's eye view (the top of the roof), (Diagram 2A) or the elevation views of the 4 (four) complete sides of the home or structure, (Diagram 2B). All rafters are included such as hip and valley rafters, even pitched common rafters and combined pitch hip and valley rafters, (Diagram 2A, 2B). This device also includes 10 notches at the bottom of increments of 0.10″ (Diagram 1) each notch is labeled A through J. And set 0.10″ down from 3′-0″ at ¼″=1′-0″. If a set of drawings is not to scale, the user will simply locate an item that is 3′-0″ on their drawings. This is most commonly a door or a window. The user will then line that known 3′-0″ up with the notches on the device, (Diagram 1) select the corresponding letter and the entire scale will convert down or up to that specific scale required.

This device also has the capabilities to allow the user to mark on the drawings, whether it be the bird's eye view (top of roof), or a regular wall, 16″ on center for stud and rafter placement. (Diagram 2D) This allows for quick estimating when rafters are not shown on a set of plans.

Method of obtaining Rafter calculations to be displayed on the LCD panel are as follows:

**the horizontal length divided by the rafter length equals the divider or the amount of spacing between the bars on each scale**

See diagram 3—this is a sample of the derivative of ONE of the calculations shown below. One bar of Diagram 3 is what will actually be displayed.

| | | | | |
|---|---|---|---|---|
| Roof | Rafter | Horizontal | Divider in | Divider in |
| Pitch | Length | Length | feet | inches |

Even Pitched Hip's and Valley's Elevation View

| | | | | | |
|---|---|---|---|---|---|
| 2 in 12 | 22′-10.0625″ | 16′-2.6563″ | .710′ | 8.5199″ | 466 |
| 3 in 12 | 23′-0.6875″ | 16′-5.9063″ | .715′ | 8.580″ | 467 |
| 4 in 12 | 23′-4.2188″ | 16′-10.375″ | .722′ | 8.6639″ | 468 |
| 5 in 12 | 23′-8.625″ | 17′-4″ | .731′ | 8.7719″ | 469 |
| 6 in 12 | 24′-1.8438″ | 17′-10.6563″ | .741′ | 8.892″ | 470 |
| 7 in 12 | 24′-7.8125″ | 18′-6.2813″ | .751′ | 9.0118″ | 471 |
| 8 in 12 | 25′-2.5313″ | 19′-2.750″ | .763′ | 9.1558″ | 472 |
| 9 in 12 | 25′-9.9375″ | 20′-0″ | .774′ | 9.2879″ | 473 |
| 10 in 12 | 26′-5.9688″ | 20′-9.9375″ | .786′ | 9.4318″ | 474 |
| 11 in 12 | 27′-2.5625″ | 21′-8.4688″ | .798′ | 9.5758″ | 475 |
| 12 in 12 | 27′-11.7188″ | 22′-7.5313″ | .809′ | 9.7079″ | 476 |
| 13 in 12 | 28′-9.375″ | 23′-7.0625″ | .820′ | 9.8398″ | 477 |
| 14 in 12 | 29′-7.500″ | 24′-7.0313″ | .830′ | 9.9599″ | 478 |
| 15 in 12 | 30′-6.0313″ | 25′-7.3438″ | .840′ | 10.080″ | 479 |
| 16 in 12 | 31′-4.9688″ | 26′-8.000″ | .849′ | 10.188″ | 480 |

Even Pitched Hip's and Valley's Bird's Eye Views

| | | | | | |
|---|---|---|---|---|---|
| 2 in 12 | 22′-10.0625″ | 22′-7.5313″ | .991′ | 11.892″ | 451 |
| 3 in 12 | 23′-0.6875″ | 22′-7.5313″ | .981′ | 11.7719″ | 452 |
| 4 in 12 | 23′-4.2188″ | 22′-7.5313″ | .969′ | 11.628″ | 453 |
| 5 in 12 | 23′-8.625″ | 22′-7.5313″ | .954′ | 11.4478″ | 454 |
| 6 in 12 | 24′-1.8438″ | 22′-7.5313″ | .937′ | 11.2438″ | 455 |
| 7 in 12 | 24′-7.8125″ | 22′-7.5313″ | .918′ | 11.016″ | 456 |
| 8 in 12 | 25′-2.5313″ | 22′-7.5313″ | .898′ | 10.7758″ | 457 |
| 9 in 12 | 25′-9.9375″ | 22′-7.5313″ | .876′ | 10.5118″ | 458 |
| 10 in 12 | 26′-5.9688″ | 22′-7.5313″ | .854′ | 10.2478″ | 459 |
| 11 in 12 | 27′-2.5625″ | 22′-7.5313″ | .831′ | 9.9719″ | 460 |
| 12 in 12 | 27′-11.7188″ | 22′-7.5313″ | .809′ | 9.7079″ | 461 |
| 13 in 12 | 28′-9.375″ | 22′-7.5313″ | .786′ | 9.4318″ | 462 |
| 14 in 12 | 29′-7.500″ | 22′-7.5313″ | .764′ | 9.1678″ | 463 |
| 15 in 12 | 30′-6.0313″ | 22′-7.5313″ | .742′ | 8.9038″ | 464 |
| 16 in 12 | 31′-4.9688″ | 22′-7.5313″ | .720′ | 8.6398″ | 465 |

4 in 12 Uneven Pitches - Elevation Views - Hip Ridges

| | | | | | |
|---|---|---|---|---|---|
| 4 and 2 | 18′-1.8438″ | 16′-2.6563″ | .894′ | 10.7279″ | 239 |
| 4 and 3 | 20′-5.8438″ | 16′-5.9063″ | .805′ | 9.6599″ | 240 |
| 4 and 5 | 21′-3.4688″ | 13′-10.4063″ | .651′ | 7.8118″ | 241 |
| 4 and 6 | 20′-0.9375″ | 11′-11.0938″ | .594′ | 7.128″ | 242 |
| 4 and 7 | 19′-3.75″ | 10′-7.0313″ | .548′ | 6.5758″ | 243 |
| 4 and 8 | 18′-9.5625″ | 9′-7.375″ | .511′ | 6.1319″ | 244 |
| 4 and 9 | 18′-5.25″ | 8′-10.6563″ | .482′ | 5.784″ | 245 |
| 4 and 10 | 18′-2.0938″ | 8′-3.9688″ | .458′ | 5.4958″ | 246 |
| 4 and 11 | 17′-11.7188″ | 7′-10.7188″ | .439′ | 5.268″ | 247 |
| 4 and 12 | 17′-9.9375″ | 7′-6.500″ | .423′ | 5.0758″ | 248 |
| 4 and 13 | 17′-8.500″ | 7′-3.0938″ | .410′ | 4.9198″ | 249 |
| 4 and 14 | 17′-7.375″ | 7′-0.2813″ | .399′ | 4.7879″ | 250 |
| 4 and 15 | 17′-6.4375″ | 6′-9.9688″ | .390′ | 4.6799″ | 251 |
| 4 and 16 | 17′-5.6875″ | 6′-8″ | .382′ | 4.5839″ | 252 |

4 in 12 Uneven Pitches - Bird's Eye Views - Hip Ridges

| | | | | | |
|---|---|---|---|---|---|
| 4 and 2 | 18′-1.8438″ | 17′-10.6563″ | .985′ | 11.8199″ | 29 |
| 4 and 3 | 20′-5.8438″ | 20′-0″ | .976′ | 11.7119″ | 30 |
| 4 and 5 | 21′-3.4688″ | 20′-5.875″ | .962′ | 11.5438″ | 31 |
| 4 and 6 | 20′-0.9375″ | 19′-2.750″ | .958′ | 11.4958″ | 32 |
| 4 and 7 | 19′-3.75″ | 18′-5.125″ | .954′ | 11.4478″ | 33 |
| 4 and 8 | 18′-9.5625″ | 17′-10.6563″ | .952′ | 11.424″ | 34 |
| 4 and 9 | 18′-5.25″ | 17′-6.0938″ | .950′ | 11.3999″ | 35 |
| 4 and 10 | 18′-2.0938″ | 17′-2.7813″ | .948′ | 11.376″ | 36 |
| 4 and 11 | 17′-11.7188″ | 17′-0.2813″ | .947′ | 11.3639″ | 37 |
| 4 and 12 | 17′-9.9375″ | 16′-10.375″ | .946′ | 11.3519″ | 38 |
| 4 and 13 | 17′-8.500″ | 16′-8.875″ | .945′ | 11.3398″ | 39 |
| 4 and 14 | 17′-7.375″ | 16′-7.6875″ | .945′ | 11.3398″ | 40 |
| 4 and 15 | 17′-6.4375″ | 16′-6.7188″ | .944′ | 11.3278″ | 41 |
| 4 and 16 | 17′-5.6875″ | 16′-5.9063″ | .944′ | 11.3278″ | 42 |

3 in 12 Uneven Pitches - Elevation Views - Hip Ridges

| | | | | | |
|---|---|---|---|---|---|
| 3 and 2 | 19′-5.7188″ | 16′-2.6563″ | .833′ | 9.9958″ | 225 |
| 3 and 4 | 20′-5.8438″ | 12′-7.7813″ | .617′ | 7.4038″ | 226 |
| 3 and 5 | 19′-2.1563″ | 10′-4.8125″ | .542′ | 6.5039″ | 227 |
| 3 and 6 | 18′-5.1563″ | 8′-11.3438″ | .485′ | 5.8199″ | 228 |
| 3 and 7 | 17′-11.5625″ | 7′-11.250″ | .442′ | 5.3039″ | 229 |
| 3 and 8 | 17′-8.8438″ | 7′-2.5313″ | .407′ | 4.8839″ | 230 |
| 3 and 9 | 17′-5.2813″ | 6′-8″ | .382′ | 4.5839″ | 231 |
| 3 and 10 | 17′-3.4063″ | 6′-2.9688″ | .361′ | 4.3319″ | 232 |
| 3 and 11 | 17′-2″ | 5′-11.0313″ | .345′ | 4.1398″ | 233 |
| 3 and 12 | 17′-0.9375″ | 5′-7.875″ | .331′ | 3.9719″ | 234 |
| 3 and 13 | 17′-0.125″ | 5′-5.3125″ | .320′ | 3.8398″ | 235 |
| 3 and 14 | 16′-11.4375″ | 5′-3.2188″ | .311′ | 3.7318″ | 236 |
| 3 and 15 | 16′-10.9063″ | 5′-1.4688″ | .303′ | 3.6358″ | 237 |
| 3 and 16 | 16′-10.4688″ | 5′-0″ | .296′ | 3.5519″ | 238 |

3 in 12 Uneven Pitches - Bird's Eye View - Hip Ridges

| | | | | | |
|---|---|---|---|---|---|
| 3 and 2 | 19′-5.7188″ | 19′-2.75″ | .987′ | 11.844″ | 15 |
| 3 and 4 | 20′-5.8438″ | 20′-0″ | .976′ | 11.7119″ | 16 |
| 3 and 5 | 19′-2.1563″ | 18′-7.9063″ | .973′ | 11.6759″ | 17 |
| 3 and 6 | 18′-5.1563″ | 17′-10.6563″ | .971′ | 11.6518″ | 18 |
| 3 and 7 | 17′-11.5625″ | 17′-4.875″ | .969′ | 11.628″ | 19 |
| 3 and 8 | 17′-8.8438″ | 17′-1.0625″ | .963′ | 11.5559″ | 20 |
| 3 and 9 | 17′-5.2813″ | 16′-10.375″ | .967′ | 11.6038″ | 21 |
| 3 and 10 | 17′-3.4063″ | 16′-8.4375″ | .966′ | 11.5918″ | 22 |
| 3 and 11 | 17′-2″ | 16′-7″ | .966′ | 11.5918″ | 23 |
| 3 and 12 | 17′-0.9375″ | 16′-5.9063″ | .966′ | 11.5918″ | 24 |
| 3 and 13 | 17′-0.125″ | 16′-5.0313″ | .965′ | 11.580″ | 25 |
| 3 and 14 | 16′-11.4375″ | 16′-4.3438″ | .965′ | 11.580″ | 26 |
| 3 and 15 | 16′-10.9063″ | 16′-3.8125″ | .965′ | 11.580″ | 27 |
| 3 and 16 | 16′-10.4688″ | 16′-3.3438″ | .965′ | 11.580″ | 28 |

2 in 12 Uneven Pitches - Elevation Views - Hip Ridges

| | | | | | |
|---|---|---|---|---|---|
| 2 and 3 | 19′-5.7188″ | 10′-11.9375″ | .565′ | 6.7798″ | 211 |
| 2 and 4 | 18′-1.8438″ | 8′-5.1875″ | .464′ | 5.5679″ | 212 |
| 2 and 5 | 17′-6.0938″ | 6′-11.1875″ | .396′ | 4.752″ | 213 |
| 2 and 6 | 17′-1.75″ | 5′-11.5625″ | .348′ | 4.1759″ | 214 |
| 2 and 7 | 16′-11.0938″ | 5′-3.500″ | .313′ | 3.7559″ | 215 |
| 2 and 8 | 16′-9.3438″ | 4′-9.6875″ | .287′ | 3.4439″ | 216 |
| 2 and 9 | 16′-8.1563″ | 4′-5.3438″ | .267′ | 3.204″ | 217 |
| 2 and 10 | 16′-7.2813″ | 4′-2.000″ | .251′ | 3.0118″ | 218 |
| 2 and 11 | 16′-6.6563″ | 3′-11.3438″ | .238′ | 2.8558″ | 219 |
| 2 and 12 | 16′-6.1563″ | 3′-9.250″ | .228′ | 2.736″ | 220 |
| 2 and 13 | 16′-5.7813″ | 3′-7.5625″ | .220′ | 2.6398″ | 221 |
| 2 and 14 | 16′-5.4688″ | 3′-6.1563″ | .213′ | 2.5559″ | 222 |
| 2 and 15 | 16′-5.2188″ | 3′-4.9688″ | .208′ | 2.4958″ | 223 |
| 2 and 16 | 16′-5.0313″ | 3′-4″ | .203′ | 2.4358″ | 224 |

2 in 12 Uneven Pitches Bird's Eye Views - Hip Ridges

| | | | | | |
|---|---|---|---|---|---|
| 2 and 3 | 19′-5.7188″ | 19′-2.750″ | .987′ | 11.844″ | 1 |
| 2 and 4 | 18′-1.8438″ | 17′-10.6563″ | .985′ | 11.8199″ | 2 |
| 2 and 5 | 17′-6.0938″ | 17′-2.7813″ | .984′ | 11.8078″ | 3 |
| 2 and 6 | 17′-1.75″ | 16′-10.375″ | .984′ | 11.8078″ | 4 |
| 2 and 7 | 16′-11.0938″ | 16′-7.6875″ | .983′ | 11.7958″ | 5 |
| 2 and 8 | 16′-9.3438″ | 16′-5.9063″ | .983′ | 11.7958″ | 6 |
| 2 and 9 | 16′-8.1563″ | 16′-4.6875″ | .983′ | 11.7958″ | 7 |
| 2 and 10 | 16′-7.2813″ | 16′-3.8125″ | .983′ | 11.7958″ | 8 |
| 2 and 11 | 16′-6.6563″ | 16′-3.1563″ | .982′ | 11.784″ | 9 |
| 2 and 12 | 16′-6.1563″ | 16′-2.6563″ | .982′ | 11.784″ | 10 |
| 2 and 13 | 16′-5.7813″ | 16′-2.250″ | .982′ | 11.784″ | 11 |
| 2 and 14 | 16′-5.4688″ | 16′-1.9375″ | .982′ | 11.784″ | 12 |
| 2 and 15 | 16′-5.2188″ | 16′-1.6875″ | .982′ | 11.784″ | 13 |
| 2 and 16 | 16′-5.0313″ | 16′-1.500″ | .982′ | 11.784″ | 14 |

Common Rafters Elevation View's

| | | | | | |
|---|---|---|---|---|---|
| 2 in 12 | 16′-1.2813″ | 3′-1.5″ | .194′ | 2.3278″ | 436 |
| 3 in 12 | 16′-4.9375″ | 4′-5.5″ | .272′ | 3.2638″ | 437 |
| 4 in 12 | 16′-9.750″ | 5′-9.5″ | .344′ | 4.128″ | 438 |
| 5 in 12 | 17′-3.6875″ | 7′-1.5″ | .412′ | 4.9439″ | 439 |
| 6 in 12 | 17′-10.5938″ | 8′-5.5″ | .473′ | 5.6759″ | 440 |
| 7 in 12 | 18′-6.4375″ | 9′-9.5″ | .528′ | 6.3359″ | 441 |
| 8 in 12 | 19′-3.0938″ | 11′-1.5″ | .578′ | 6.9358″ | 442 |
| 9 in 12 | 20′-0.500″ | 12′-5.5″ | .622′ | 7.4638″ | 443 |
| 10 in 12 | 20′-10.5313″ | 13′-9.5″ | .661′ | 7.9318″ | 444 |
| 11 in 12 | 21′-9.125″ | 15′-1.5″ | .695′ | 8.3398″ | 445 |
| 12 in 12 | 22′-8.250″ | 16′-5.5″ | .725′ | 8.6998″ | 446 |
| 13 in 12 | 23′-7.7813″ | 17′-9.5″ | .752′ | 9.0239″ | 447 |
| 14 in 12 | 24′-7.750″ | 19′-1.5″ | .776′ | 9.3118″ | 448 |
| 15 in 12 | 25′-8.0313″ | 20′-5.5″ | .797′ | 9.564″ | 449 |
| 16 in 12 | 26′-8.6563″ | 21′-9.5″ | .816′ | 9.7918″ | 450 |

Common Rafters Bird's Eye View

| | | | | | |
|---|---|---|---|---|---|
| 2 in 12 | 16′-1.2813″ | 16′-0″ | .993′ | 11.9158″ | 421 |
| 3 in 12 | 16′-4.9375″ | 16′-0″ | .975′ | 11.6998″ | 422 |
| 4 in 12 | 16′-9.750″ | 16′-0″ | .952′ | 11.424″ | 423 |
| 5 in 12 | 17′-3.6875″ | 16′-0″ | .924′ | 11.0878″ | 424 |
| 6 in 12 | 17′-10.5938″ | 16′-0″ | .895′ | 10.7399″ | 425 |
| 7 in 12 | 18′-6.4375″ | 16′-0″ | .863′ | 10.3558″ | 426 |
| 8 in 12 | 19′-3.0938″ | 16′-0″ | .831′ | 9.9719″ | 427 |
| 9 in 12 | 20′-0.500″ | 16′-0″ | .798′ | 9.5758″ | 428 |
| 10 in 12 | 20′-10.5313″ | 16′-0″ | .766′ | 9.1919″ | 429 |
| 11 in 12 | 21′-9.125″ | 16′-0″ | .735′ | 8.8199″ | 430 |
| 12 in 12 | 22′-8.250″ | 16′-0″ | .705′ | 8.4599″ | 431 |
| 13 in 12 | 23′-7.7813″ | 16′-0″ | .677′ | 8.1238″ | 432 |
| 14 in 12 | 24′-7.750″ | 16′-0″ | .649′ | 7.7879″ | 433 |
| 15 in 12 | 25′-8.0313″ | 16′-0″ | .623′ | 7.4759″ | 434 |
| 16 in 12 | 26′-8.6563″ | 16′-0″ | .599′ | 7.188″ | 435 |

13 in 12 Uneven Pitches - Bird's Eye Views - Hip Ridges

| | | | | | |
|---|---|---|---|---|---|
| 13 and 2 | 16′-5.7813″ | 16′-2.250″ | .982′ | 11.784″ | 155 |
| 13 and 3 | 17′-0.125″ | 16′-5.0313″ | .965′ | 11.580″ | 156 |
| 13 and 4 | 17′-8.500″ | 16′-8.875″ | .945′ | 11.3398″ | 157 |
| 13 and 5 | 18′-6.7188″ | 17′-1.6875″ | .924′ | 11.0878″ | 158 |
| 13 and 6 | 19′-6.500″ | 17′-7.4375″ | .902′ | 10.8238″ | 159 |
| 13 and 7 | 20′-7.6563″ | 18′-2.0313″ | .880′ | 10.5598″ | 160 |
| 13 and 8 | 21′-9.9688″ | 18′-9.4063″ | .860′ | 10.3199″ | 161 |
| 13 and 9 | 23′-1.25″ | 19′-5.4688″ | .842′ | 10.1038″ | 162 |
| 13 and 10 | 24′-5.3438″ | 20′-2.1875″ | .826′ | 9.9119″ | 163 |
| 13 and 11 | 25′-10.125″ | 20′-11.4688″ | .811′ | 9.7318″ | 164 |
| 13 and 12 | 27′-3.500″ | 21′-9.250″ | .798′ | 9.5758″ | 165 |
| 13 and 14 | 28′-1.9688″ | 21′-9.9688″ | .775′ | 9.300″ | 166 |
| 13 and 15 | 27′-7.8438″ | 21′-2.0313″ | .766′ | 9.1919″ | 167 |
| 13 and 16 | 27′-2.75″ | 20′-7.3438″ | .757′ | 9.0839″ | 168 |

9 in 12 Uneven Pitches - Bird's Eye Views - Hip Ridges

| | | | | | |
|---|---|---|---|---|---|
| 9 and 2 | 16′-8.1563″ | 16′-4.6875″ | .983′ | 11.7958″ | 99 |
| 9 and 3 | 17′-5.2813″ | 16′-10.375″ | .967′ | 11.6038″ | 100 |
| 9 and 4 | 18′-5.25″ | 17′-6.0938″ | .950′ | 11.3999″ | 101 |
| 9 and 5 | 19′-7.625″ | 18′-3.625″ | .932′ | 11.1838″ | 102 |
| 9 and 6 | 21′-0.0313″ | 19′-2.7188″ | .915′ | 10.9798″ | 103 |
| 9 and 7 | 22′-6.0938″ | 20′-3.2188″ | .900′ | 10.800″ | 104 |
| 9 and 8 | 24′-1.4688″ | 21′-4.8438″ | .887′ | 10.6439″ | 105 |
| 9 and 10 | 24′-10.4063″ | 21′-6.2813″ | .866′ | 10.392″ | 106 |
| 9 and 11 | 24′-1.5938″ | 20′-8.0313″ | .856′ | 10.2719″ | 107 |
| 9 and 12 | 23′-6.7188″ | 19′-11.9688″ | .849′ | 10.188″ | 108 |
| 9 and 13 | 23′1.25″ | 19′-5.500″ | .842′ | 10.1038″ | 109 |
| 9 and 14 | 22′-8.8125″ | 19′-0.2188″ | .837′ | 10.0438″ | 110 |
| 9 and 15 | 22′-5.1875″ | 18′-7.875″ | .832′ | 9.9838″ | 111 |
| 9 and 16 | 22′-2.1875″ | 18′-4.2813″ | .828′ | 9.9358″ | 112 |

5 in 12 Uneven Pitches - Bird's Eye Views - Hip Ridges

| | | | | | |
|---|---|---|---|---|---|
| 5 and 2 | 17′-6.0938″ | 17′-2.7813″ | .984′ | 11.8078″ | 43 |
| 5 and 3 | 19′-2.1563″ | 18′-7.9063″ | .973′ | 11.6759″ | 44 |
| 5 and 4 | 21′-3.4688″ | 20′-5.875″ | .962′ | 11.5438″ | 45 |
| 5 and 6 | 22′-0.0938″ | 20′-9.9063″ | .946′ | 11.3519″ | 46 |
| 5 and 7 | 20′-10.9063″ | 19′-7.9375″ | .940′ | 11.2798″ | 47 |
| 5 and 8 | 20′-1.9688″ | 18′-10.4063″ | .936′ | 11.2318″ | 48 |
| 5 and 9 | 19′-7.625″ | 18′-3.625″ | .932′ | 11.1838″ | 49 |
| 5 and 10 | 19′-3″ | 17′-10.6563″ | .929′ | 11.1479″ | 50 |
| 5 and 11 | 18′-11.5313″ | 17′-6.9063″ | .927′ | 11.1238″ | 51 |
| 5 and 12 | 18′-8.8438″ | 17′-4″ | .925′ | 11.0999″ | 52 |
| 5 and 13 | 18′-6.7188″ | 17′-1.6875″ | .924′ | 11.0878″ | 53 |
| 5 and 14 | 18′-5.0313″ | 16′-11.875″ | .922′ | 11.064″ | 54 |
| 5 and 15 | 18′-3.6563″ | 16′-10.375″ | .921′ | 11.0519″ | 55 |
| 5 and 16 | 18′-2.500″ | 16′-9.1563″ | .921′ | 11.0519″ | 56 |

13 in 12 Uneven Pitches - Elevation Views - Hip Ridges

| | | | | | |
|---|---|---|---|---|---|
| 13 and 2 | 16′-5.7813″ | 16′-2.6563″ | .984′ | 11.8078″ | 365 |
| 13 and 3 | 17′-0.125″ | 16′-5.9063″ | .970′ | 11.6398″ | 366 |
| 13 and 4 | 17′-8.500″ | 16′-10.375″ | .952′ | 11.424″ | 367 |
| 13 and 5 | 18′-6.7188″ | 17′-4″ | .934′ | 11.2079″ | 368 |
| 13 and 6 | 19′-6.500″ | 17′-10.6563″ | .915′ | 10.9798″ | 369 |
| 13 and 7 | 20′-7.6563″ | 18′-6.2813″ | .898′ | 10.7758″ | 370 |
| 13 and 8 | 21′-9.9688″ | 19′-2.75″ | .881′ | 10.5719″ | 371 |
| 13 and 9 | 23′-1.25″ | 20′-0″ | .866′ | 10.392″ | 372 |
| 13 and 10 | 24′-5.3438″ | 20′-9.9375″ | .852′ | 10.2239″ | 373 |
| 13 and 11 | 25′-10.125″ | 21′-8.4688″ | .840′ | 10.080″ | 374 |
| 13 and 12 | 27′-3.500″ | 22′-7.5313″ | .829′ | 9.9478″ | 375 |
| 13 and 14 | 28′-1.9688″ | 22′-9.9375″ | .811′ | 9.7318″ | 376 |
| 13 and 15 | 27′-7.8438″ | 22′-2.375″ | .803′ | 9.6358″ | 377 |
| 13 and 16 | 27′-2.75″ | 21′-8″ | .796′ | 9.5519″ | 378 |

9 in 12 Uneven Pitches - Elevation Views - Hip Ridges

| | | | | | |
|---|---|---|---|---|---|
| 9 and 2 | 16′-8.1563″ | 16′-2.6563″ | .973′ | 11.6759″ | 309 |
| 9 and 3 | 17′-5.2813″ | 16′-5.9063″ | .946′ | 11.3519″ | 310 |
| 9 and 4 | 18′-5.25″ | 16′-10.375″ | .915′ | 10.9798″ | 311 |
| 9 and 5 | 19′-7.625″ | 17′-4″ | .883′ | 10.596″ | 312 |
| 9 and 6 | 21′-0.0313″ | 17′-10.6563″ | .852′ | 10.2239″ | 313 |
| 9 and 7 | 22′-6.0938″ | 18′-6.2813″ | .823′ | 9.876″ | 314 |
| 9 and 8 | 24′-1.4688″ | 19′-2.750″ | .797′ | 9.564″ | 315 |
| 9 and 10 | 24′-10.4063″ | 18′-8.9375″ | .754′ | 9.048″ | 316 |
| 9 and 11 | 24′-1.5938″ | 17′-9.0938″ | .736′ | 8.8319″ | 317 |
| 9 and 12 | 23′-6.7188″ | 16′-11.6563″ | .720′ | 8.6398″ | 318 |
| 9 and 13 | 23′1.25″ | 16′-3.9688″ | .707′ | 8.4838″ | 319 |
| 9 and 14 | 22′-8.8125″ | 15′-9.6563″ | .695′ | 8.3398″ | 320 |
| 9 and 15 | 22′-5.1875″ | 15′-4.4063″ | .685′ | 8.220″ | 321 |
| 9 and 16 | 22′-2.1875″ | 15′-0″ | .676′ | 8.112″ | 322 |

5 in 12 Uneven Pitches - Elevation Views - Hip Ridges

| | | | | | |
|---|---|---|---|---|---|
| 5 and 2 | 17′-6.0938″ | 16′-2.6563″ | .927′ | 11.1238″ | 253 |
| 5 and 3 | 19′-2.1563″ | 16′-5.9063″ | .860′ | 10.3199″ | 254 |
| 5 and 4 | 21′-3.4688″ | 16′-10.375″ | .792′ | 9.5039″ | 255 |
| 5 and 6 | 22′-0.0938″ | 14′-10.875″ | .677′ | 8.1238″ | 256 |
| 5 and 7 | 20′-10.9063″ | 13′-2.7813″ | .633′ | 7.596″ | 257 |
| 5 and 8 | 20′-1.9688″ | 12′-0.2188″ | .596′ | 7.1518″ | 258 |
| 5 and 9 | 19′-7.625″ | 11′-1.3438″ | .566′ | 6.7918″ | 259 |
| 5 and 10 | 19′-3″ | 10′-4.9688″ | .541′ | 6.4919″ | 260 |
| 5 and 11 | 18′-11.5313″ | 9′-10.4063″ | .520′ | 6.2399″ | 261 |
| 5 and 12 | 18′-8.8438″ | 9′-5.125″ | .503′ | 6.0359″ | 262 |
| 5 and 13 | 18′-6.7188″ | 9′-0.875″ | .489′ | 5.8679″ | 263 |
| 5 and 14 | 18′-5.0313″ | 8′-9.375″ | .477′ | 5.7239″ | 264 |
| 5 and 15 | 18′-3.6563″ | 8′-6.4375″ | .466′ | 5.5918″ | 265 |
| 5 and 16 | 18′-2.500″ | 8′-4″ | .458′ | 5.4958″ | 266 |

6 in 12 Uneven Pitches - Bird's Eye Views - Hip Ridges

| | | | | | |
|---|---|---|---|---|---|
| 6 and 2 | 17′-1.75″ | 16′-10.375″ | .984′ | 11.8078″ | 57 |
| 6 and 3 | 18′-5.1563″ | 17′-10.6563″ | .971′ | 11.6518″ | 58 |
| 6 and 4 | 20′-0.9375″ | 19′-2.75″ | .958′ | 11.4958″ | 59 |
| 6 and 5 | 22′-0.0938″ | 20′-9.9063″ | .946′ | 11.3519″ | 60 |
| 6 and 7 | 22′-8.4375″ | 21′-0.8438″ | .928′ | 11.1358″ | 61 |
| 6 and 8 | 21′-8.5313″ | 19′-11.9688″ | .921′ | 11.0519″ | 62 |
| 6 and 9 | 21′-0.0313″ | 19′-2.75″ | .916′ | 10.9919″ | 63 |
| 6 and 10 | 20′-5.7813″ | 18′-7.9063″ | .911′ | 10.9318″ | 64 |
| 6 and 11 | 20′-1.0625″ | 18′-2.6875″ | .907′ | 10.8839″ | 65 |
| 6 and 12 | 19′-9.4063″ | 17′-10.6563″ | .904′ | 10.8479″ | 66 |
| 6 and 13 | 19′-6.500″ | 17′-7.4375″ | .902′ | 10.8238″ | 67 |
| 6 and 14 | 19′-4.1875″ | 17′-4.875″ | .900′ | 10.800″ | 68 |
| 6 and 15 | 19′-2.3125″ | 17′-2.7813″ | .898′ | 10.7758″ | 69 |
| 6 and 16 | 19′-0.75″ | 17′-1.0313″ | .896′ | 10.752″ | 70 |

10 in 12 Uneven Pitches - Bird's Eye Views - Hip Ridges

| | | | | | |
|---|---|---|---|---|---|
| 10 and 2 | 16′-7.2813″ | 16′-3.7813″ | .982′ | 11.784″ | 113 |
| 10 and 3 | 17′-3.4063″ | 16′-8.4375″ | .966′ | 11.5918″ | 114 |
| 10 and 4 | 18′-2.0938″ | 17′-2.7813″ | .948′ | 11.376″ | 115 |
| 10 and 5 | 19′-3″ | 17′-10.625″ | .929′ | 11.1479″ | 116 |
| 10 and 6 | 20′-5.7813″ | 18′-7.875″ | .911′ | 10.9318″ | 117 |
| 10 and 7 | 21′-10.125″ | 19′-6.3438″ | .894′ | 10.7279″ | 118 |
| 10 and 8 | 23′-3.75″ | 20′-5.8438″ | .879′ | 10.548″ | 119 |
| 10 and 9 | 24′-10.4063″ | 21′-6.2813″ | .866′ | 10.392″ | 120 |
| 10 and 11 | 25′-7.7188″ | 21′-7.4375″ | .843′ | 10.1159″ | 121 |
| 10 and 12 | 24′-11.7188″ | 20′-9.9063″ | .834′ | 10.0079″ | 122 |
| 10 and 13 | 24′-5.3438″ | 20′-2.1875″ | .826′ | 9.9119″ | 123 |
| 10 and 14 | 24′-0.1563″ | 19′-7.9063″ | .819′ | 9.8278″ | 124 |
| 10 and 15 | 23′-7.9375″ | 19′-2.7188″ | .813′ | 9.7559″ | 125 |
| 10 and 16 | 23′-4.4063″ | 18′-10.375″ | .807′ | 9.6838″ | 126 |

14 in 12 Uneven Pitches - Bird's Eye Views - Hip Ridges

| | | | | | |
|---|---|---|---|---|---|
| 14 and 2 | 16′-5.4688″ | 16′-1.9375″ | .982′ | 11.784″ | 169 |
| 14 and 3 | 16′-11.4375″ | 16′-4.3438″ | .965′ | 11.580″ | 170 |
| 14 and 4 | 17′-7.375″ | 16′-7.6563″ | .945′ | 11.3398″ | 171 |
| 14 and 5 | 18′-5.0313″ | 16′-11.8438″ | .922′ | 11.064″ | 172 |
| 14 and 6 | 19′-4.1875″ | 17′-4.875″ | .900′ | 10.800″ | 173 |
| 14 and 7 | 20′-4.6563″ | 17′-10.625″ | .877′ | 10.5239″ | 174 |
| 14 and 8 | 21′-6.250″ | 18′-5.0938″ | .856′ | 10.2719″ | 175 |
| 14 and 9 | 22′-8.8125″ | 19′-0.2188″ | .837′ | 10.0438″ | 176 |
| 14 and 10 | 24′-0.1563″ | 19′-7.9063″ | .819′ | 9.8278″ | 177 |
| 14 and 11 | 25′-4.2188″ | 20′-4.125″ | .802′ | 9.6238″ | 178 |
| 14 and 12 | 26′-8.8438″ | 21′-0.8438″ | .788′ | 9.456″ | 179 |
| 14 and 13 | 28′-1.9688″ | 21′-9.9688″ | .775′ | 9.30″ | 180 |
| 14 and 15 | 29′-0.750″ | 21′-10.5938″ | .753′ | 9.0359″ | 181 |
| 14 and 16 | 28′-7.125″ | 21′-3.0625″ | .743′ | 8.9158″ | 182 |

14 in 12 Uneven Pitches - Elevation Views - Hip Ridges

| | | | | | |
|---|---|---|---|---|---|
| 14 and 2 | 16′-5.4688″ | 16′-2.6563″ | .986′ | 11.8319″ | 379 |
| 14 and 3 | 16′-11.4375″ | 16′-5.9063″ | .973′ | 11.6759″ | 380 |
| 14 and 4 | 17′-7.375″ | 16′-10.375″ | .957′ | 11.4838″ | 381 |
| 14 and 5 | 18′-5.0313″ | 17′-4″ | .941′ | 11.2918″ | 382 |
| 14 and 6 | 19′-4.1875″ | 17′-10.6563″ | .924′ | 11.0878″ | 383 |
| 14 and 7 | 20′-4.6563″ | 18′-6.2813″ | .909′ | 10.908″ | 384 |
| 14 and 8 | 21′-6.250″ | 19′-2.750″ | .894′ | 10.7279″ | 385 |
| 14 and 9 | 22′-8.8125″ | 20′-0″ | .880′ | 10.5598″ | 386 |
| 14 and 10 | 24′-0.1563″ | 20′-9.9375″ | .867′ | 10.4038″ | 387 |
| 14 and 11 | 25′-4.2188″ | 21′-8.4688″ | .856′ | 10.2719″ | 388 |
| 14 and 12 | 26′-8.8438″ | 22′-7.5313″ | .846′ | 10.1518″ | 389 |
| 14 and 13 | 28′-1.9688″ | 23′-7.0625″ | .838′ | 10.0559″ | 390 |
| 14 and 15 | 29′-0.750″ | 23′-10.875″ | .823′ | 9.876″ | 391 |
| 14 and 16 | 28′-7.125″ | 23′-4″ | .816′ | 9.7818″ | 392 |

10 in 12 Uneven Pitches - Elevation Views - Hip Ridges

| | | | | | |
|---|---|---|---|---|---|
| 10 and 2 | 16′-7.2813″ | 16′-2.6563″ | .977′ | 11.7239″ | 323 |
| 10 and 3 | 17′-3.4063″ | 16′-5.9063″ | .954′ | 11.4478″ | 324 |
| 10 and 4 | 18′-2.0938″ | 16′-10.375″ | .928′ | 11.1358″ | 325 |
| 10 and 5 | 19′-3″ | 17′-4″ | .900′ | 10.800″ | 326 |
| 10 and 6 | 20′-5.7813″ | 17′-10.6563″ | .873′ | 10.4759″ | 327 |
| 10 and 7 | 21′-10.125″ | 18′-6.2813″ | .848′ | 10.1759″ | 328 |
| 10 and 8 | 23′-3.75″ | 19′-2.750″ | .825′ | 9.8999″ | 329 |
| 10 and 9 | 24′-10.4063″ | 20′-0″ | .804′ | 9.6479″ | 330 |
| 10 and 11 | 25′-7.7188″ | 19′-8.7813″ | .769′ | 9.2279″ | 331 |
| 10 and 12 | 24′-11.7188″ | 18′-10.2813″ | .755′ | 9.0598″ | 332 |
| 10 and 13 | 24′-5.3438″ | 18′-1.750″ | .742′ | 8.9038″ | 333 |
| 10 and 14 | 24′-0.1563″ | 17′-6.7188″ | .731′ | 8.7719″ | 334 |
| 10 and 15 | 23′-7.9375″ | 17′-0.9063″ | .722′ | 8.6639″ | 335 |
| 10 and 16 | 23′-4.4063″ | 16′-8″ | .713′ | 8.5559″ | 336 |

6 in 12 Uneven Pitches - Elevation Views - Hip Ridges

| | | | | | |
|---|---|---|---|---|---|
| 6 and 2 | 17′-1.75″ | 16′-2.6563″ | .946′ | 11.3519″ | 267 |
| 6 and 3 | 18′-5.1563″ | 16′-5.9063″ | .895′ | 10.7399″ | 268 |
| 6 and 4 | 20′-0.9375″ | 16′-10.375″ | .840′ | 10.080″ | 269 |
| 6 and 5 | 22′-0.0938″ | 17′-4″ | .788′ | 9.456″ | 270 |
| 6 and 7 | 22′-8.4375″ | 15′-10.5313″ | .699′ | 8.3878″ | 271 |
| 6 and 8 | 21′-8.5313″ | 14′-5.0625″ | .664′ | 7.9678″ | 272 |
| 6 and 9 | 21′-0.0313″ | 13′-4.000″ | .635′ | 7.6198″ | 273 |
| 6 and 10 | 20′-5.7813″ | 12′-5.9688″ | .610′ | 7.3199″ | 274 |
| 6 and 11 | 20′-1.0625″ | 11′-10.0625″ | .589′ | 7.0679″ | 275 |
| 6 and 12 | 19′-9.4063″ | 11′-3.750″ | .572′ | 6.8639″ | 276 |
| 6 and 13 | 19′-6.500″ | 10′-10.6563″ | .557′ | 6.6838″ | 277 |
| 6 and 14 | 19′-4.1875″ | 10′-6.4375″ | .545′ | 6.5399″ | 278 |
| 6 and 15 | 19′-2.3125″ | 10′-2.9375″ | .534′ | 6.408″ | 279 |
| 6 and 16 | 19′-0.75″ | 10′-0″ | .525′ | 6.300″ | 280 |

7 in 12 Uneven Pitches - Bird's Eye Views - Hip Ridges

| | | | | | |
|---|---|---|---|---|---|
| 7 and 2 | 16′-11.0938″ | 16′-7.6875″ | .983′ | 11.7958″ | 71 |
| 7 and 3 | 17′-11.5625″ | 17′-4.875″ | .969′ | 11.628″ | 72 |
| 7 and 4 | 19′-3.75″ | 18′-5.125″ | .954′ | 11.4478″ | 73 |
| 7 and 5 | 20′-10.9063″ | 19′-7.9375″ | .940′ | 11.2798″ | 74 |
| 7 and 6 | 22′-8.4375″ | 21′-0.8438″ | .928′ | 11.1358″ | 75 |
| 7 and 8 | 23′-4.8438″ | 21′-3.0938″ | .908′ | 10.8959″ | 76 |
| 7 and 9 | 22′-6.0938″ | 20′-3.2188″ | .900′ | 10.800″ | 77 |
| 7 and 10 | 21′-10.125″ | 19′-6.3438″ | .894′ | 10.7279″ | 78 |
| 7 and 11 | 21′-4.0625″ | 18′-11.5625″ | .889′ | 10.6678″ | 79 |
| 7 and 12 | 20′-11.375″ | 18′-6.25″ | .884′ | 10.6078″ | 80 |
| 7 and 13 | 20′-7.6563″ | 18′-2.0625″ | .881′ | 10.5719″ | 81 |
| 7 and 14 | 20′-4.6563″ | 17′-10.6563″ | .877′ | 10.5239″ | 82 |
| 7 and 15 | 20′-2.2188″ | 17′-7.875″ | .875′ | 10.5″ | 83 |
| 7 and 16 | 20′-0.2188″ | 17′-5.5625″ | .873′ | 10.4759″ | 84 |

11 in 12 Uneven Pitches - Bird's Eye Views - Hip Ridges

| | | | | | |
|---|---|---|---|---|---|
| 11 and 2 | 16′-6.6563″ | 16′-3.125″ | .982′ | 11.784″ | 127 |
| 11 and 3 | 17′-2″ | 16′-7″ | .966′ | 11.5918″ | 128 |
| 11 and 4 | 17′-11.7188″ | 17′-0.2813″ | .947′ | 11.3639″ | 129 |
| 11 and 5 | 18′-11.5313″ | 17′-6.875″ | .927′ | 11.1238″ | 130 |
| 11 and 6 | 20′-1.0625″ | 18′-2.6875″ | .907′ | 10.8839″ | 131 |
| 11 and 7 | 21′-4.0625″ | 18′-11.5625″ | .889′ | 10.6678″ | 132 |
| 11 and 8 | 22′-8.3125″ | 19′-9.375″ | .872′ | 10.4638″ | 133 |
| 11 and 9 | 24′-1.5938″ | 20′-8.0313″ | .856′ | 10.2719″ | 134 |
| 11 and 10 | 25′-7.7188″ | 21′-7.4375″ | .843′ | 10.1159″ | 135 |
| 11 and 12 | 26′-5.4375″ | 21′-8.4375″ | .820′ | 9.8398″ | 136 |
| 11 and 13 | 25′-10.125″ | 20′-11.4688″ | .811′ | 9.7318″ | 137 |
| 11 and 14 | 25′-4.2188″ | 20′-4.125″ | .802′ | 9.6238″ | 138 |
| 11 and 15 | 24′-11.3438″ | 19′-10.0625″ | .795′ | 9.5399″ | 139 |
| 11 and 16 | 24′-7.3125″ | 19′-4.9688″ | .789′ | 9.4678″ | 140 |

15 in 12 Uneven Pitches - Bird's Eye Views - Hip Ridges

| | | | | | |
|---|---|---|---|---|---|
| 15 and 2 | 16′-5.2188″ | 16′-1.6875″ | .982′ | 11.784″ | 183 |
| 15 and 3 | 16′-10.9063″ | 16′-3.7813″ | .965′ | 11.580″ | 184 |
| 15 and 4 | 17′-6.4375″ | 16′-6.6875″ | .944′ | 11.3278″ | 185 |
| 15 and 5 | 18′-3.6563″ | 16′-10.375″ | .921′ | 11.0519″ | 186 |
| 15 and 6 | 19′-2.3125″ | 17′-2.750″ | .898′ | 10.7758″ | 187 |
| 15 and 7 | 20′-2.2188″ | 17′-7.8438″ | .875′ | 10.500″ | 188 |
| 15 and 8 | 21′-3.250″ | 18′-1.5625″ | .852′ | 10.2239″ | 189 |
| 15 and 9 | 22′-5.1875″ | 18′-7.875″ | .832′ | 9.9838″ | 190 |
| 15 and 10 | 23′-7.9375″ | 19′-2.7188″ | .813′ | 9.7559″ | 191 |
| 15 and 11 | 24′-11.3438″ | 19′-10.0625″ | .795′ | 9.5399″ | 192 |
| 15 and 12 | 26′3.3438″ | 20′-5.8438″ | .780′ | 9.360″ | 193 |
| 15 and 13 | 27′-7.8438″ | 21′-2.0313″ | .766′ | 9.1919″ | 194 |
| 15 and 14 | 29′-0.750″ | 21′-10.5938″ | .753′ | 9.0359″ | 195 |
| 15 and 16 | 29′-11.875″ | 21′-11.125″ | .731′ | 8.7719″ | 196 |

7 in 12 Uneven Pitches - Elevation Views - Hip Ridges

| | | | | | |
|---|---|---|---|---|---|
| 7 and 2 | 16′-11.0938″ | 16′-2.6563″ | .958′ | 11.4958″ | 281 |
| 7 and 3 | 17′-11.5625″ | 16′-5.9063″ | .918′ | 11.016″ | 282 |
| 7 and 4 | 19′-3.75″ | 16′-10.375″ | .873′ | 10.4759″ | 283 |
| 7 and 5 | 20′-10.9063″ | 17′-4″ | .829′ | 9.9478″ | 284 |
| 7 and 6 | 22′-8.4375″ | 17′-10.6563″ | .788′ | 9.456″ | 285 |
| 7 and 8 | 23′-4.8438″ | 16′-9.9063″ | .719′ | 8.628″ | 286 |
| 7 and 9 | 22′-6.0938″ | 15′-6.6563″ | .691′ | 8.2918″ | 287 |
| 7 and 10 | 21′-10.125″ | 14′-6.9375″ | .667′ | 8.0039″ | 288 |
| 7 and 11 | 21′-4.0625″ | 13′-9.75″ | .647′ | 7.7638″ | 289 |
| 7 and 12 | 20′-11.375″ | 13′-2.4063″ | .630′ | 7.5598″ | 290 |
| 7 and 13 | 20′-7.6563″ | 12′-8.4063″ | .615′ | 7.3799″ | 291 |
| 7 and 14 | 20′-4.6563″ | 12′-3.500″ | .603′ | 7.236″ | 292 |
| 7 and 15 | 20′-2.2188″ | 11′-11.4375″ | .592′ | 7.1038″ | 293 |
| 7 and 16 | 20′-0.2188″ | 11′-8.00″ | .583′ | 6.9958″ | 294 |

11 in 12 Uneven Pitches - Elevation Views - Hip Ridges

| | | | | | |
|---|---|---|---|---|---|
| 11 and 2 | 16′-6.6563″ | 16′-2.6563″ | .980′ | 11.7598″ | 337 |
| 11 and 3 | 17′-2″ | 16′-5.9063″ | .961′ | 11.532″ | 338 |
| 11 and 4 | 17′-11.7188″ | 16′-10.375″ | .938′ | 11.2559″ | 339 |
| 11 and 5 | 18′-11.5313″ | 17′-4″ | .914′ | 10.9678″ | 340 |
| 11 and 6 | 20′-1.0625″ | 17′-10.6563″ | .890′ | 10.6799″ | 341 |
| 11 and 7 | 21′-4.0625″ | 18′-6.2813″ | .868′ | 10.4158″ | 342 |
| 11 and 8 | 22′-8.3125″ | 19′-2.750″ | .847′ | 10.1693″ | 343 |
| 11 and 9 | 24′-1.5938″ | 20′-0″ | .829′ | 9.9478″ | 344 |
| 11 and 10 | 25′-7.7188″ | 20′-9.9375″ | .812′ | 9.7438″ | 345 |
| 11 and 12 | 26′-5.4375″ | 20′-8.9063″ | .784′ | 9.408″ | 346 |
| 11 and 13 | 25′-10.125″ | 19′-11.5313″ | .772′ | 9.2638″ | 347 |
| 11 and 14 | 25′-4.2188″ | 19′-3.8125″ | .762′ | 9.1439″ | 348 |
| 11 and 15 | 24′-11.3438″ | 18′-9.375″ | .753′ | 9.0359″ | 349 |
| 11 and 16 | 24′-7.3125″ | 18′-4″ | .745′ | 8.940″ | 350 |

15 in 12 Uneven Pitches - Elevation Views - Hip Ridges

| | | | | | |
|---|---|---|---|---|---|
| 15 and 2 | 16′-5.2188″ | 16′-2.6563″ | .987′ | 11.844″ | 393 |
| 15 and 3 | 16′-10.9063″ | 16′-5.9063″ | .975′ | 11.6998″ | 394 |
| 15 and 4 | 17′-6.4375″ | 16′-10.375″ | .962′ | 11.5438″ | 395 |
| 15 and 5 | 18′-3.6563″ | 17′-4″ | .947′ | 11.3639″ | 396 |
| 15 and 6 | 19′-2.3125″ | 17′-10.6563″ | .932′ | 11.1838″ | 397 |
| 15 and 7 | 20′-2.2188″ | 18′-6.2813″ | .918′ | 11.016″ | 398 |
| 15 and 8 | 21′-3.250″ | 19′-2.750″ | .904′ | 10.8479″ | 399 |
| 15 and 9 | 22′-5.1875″ | 20′-0″ | .892′ | 10.704″ | 400 |
| 15 and 10 | 23′-7.9375″ | 20′-9.9375″ | .880′ | 10.5598″ | 401 |
| 15 and 11 | 24′-11.3438″ | 21′-8.4688″ | .870′ | 10.440″ | 402 |
| 15 and 12 | 26′3.3438″ | 22′-7.5313″ | .861′ | 10.3319″ | 403 |
| 15 and 13 | 27′-7.8438″ | 23′-7.0625″ | .853′ | 10.236″ | 404 |
| 15 and 14 | 29′-0.750″ | 24′-7.0313″ | .846′ | 10.1518″ | 405 |
| 15 and 16 | 29′-11.875″ | 25′-0″ | .834′ | 10.0079″ | 406 |

16 in 12 Uneven Pitches - Bird's Eye Views - Hip Ridges

| | | | | | |
|---|---|---|---|---|---|
| 16 and 2 | 16′-5.0313″ | 16′-1.4688″ | .982′ | 11.784″ | 197 |
| 16 and 3 | 16′-10.4688″ | 16′-3.3438″ | .965′ | 11.580″ | 198 |
| 16 and 4 | 17′-5.6875″ | 16′-5.875″ | .944′ | 11.3278″ | 199 |
| 16 and 5 | 18-2.500″ | 16′-9.125″ | .920′ | 11.0399″ | 200 |
| 16 and 6 | 19′-0.7500″ | 17′-1.0313″ | .896′ | 10.752″ | 201 |
| 16 and 7 | 20′-0.2188″ | 17′-5.5313″ | .872′ | 10.4638″ | 202 |
| 16 and 8 | 21′-0.750″ | 17′-10.625″ | .849′ | 10.188″ | 203 |
| 16 and 9 | 22′-2.1875″ | 18′-4.250″ | .827′ | 9.924″ | 204 |
| 16 and 10 | 23′-4.4063″ | 18′-10.375″ | .807′ | 9.6838″ | 205 |
| 16 and 11 | 24′-7.3125″ | 19′-4.9375″ | .789′ | 9.4678″ | 206 |
| 16 and 12 | 25′-10.7813″ | 19′-11.9375″ | .772′ | 9.2638″ | 207 |
| 16 and 13 | 27′-2.750″ | 20′-7.3438″ | .757′ | 9.0839″ | 208 |
| 16 and 14 | 28′-7.125″ | 21′-3.0625″ | .743′ | 8.9158″ | 209 |
| 16 and 15 | 29′-11.875″ | 21′-11.125″ | .731′ | 8.7719″ | 210 |

12 in 12 Uneven Pitches - Bird's Eye Views - Hip Ridges

| | | | | | |
|---|---|---|---|---|---|
| 12 and 2 | 16′-6.1563″ | 16′-2.625″ | .982′ | 11.784″ | 141 |
| 12 and 3 | 17′-0.9375″ | 16′-5.9063″ | .966′ | 11.5918″ | 142 |
| 12 and 4 | 17′-9.9375″ | 16′-10.375″ | .946′ | 11.3519″ | 143 |
| 12 and 5 | 18′-8.8438″ | 17′-3.9688″ | .925′ | 11.0999″ | 144 |
| 12 and 6 | 19′-9.4063″ | 17′-10.625″ | .904′ | 10.8479″ | 145 |
| 12 and 7 | 20′-11.375″ | 18′-6.250″ | .884′ | 10.6078″ | 146 |
| 12 and 8 | 22′-2.5313″ | 19′-2.7188″ | .866′ | 10.392″ | 147 |
| 12 and 9V | 23′-6.7188″ | 19′-11.9688″ | .849′ | 10.188″ | 148 |
| 12 and 10 | 24′-11.7188″ | 20′-9.875″ | .834′ | 10.0079″ | 149 |
| 12 and 11 | 26′-5.4375″ | 21′-8.4063″ | .820′ | 9.8398″ | 150 |
| 12 and 13 | 27′3.5″ | 21′-9.25″ | .798′ | 9.5758″ | 151 |
| 12 and 14 | 26′-8.8438″ | 21′-0.8438″ | .788′ | 9.456″ | 152 |
| 12 and 15 | 26′-3.3438″ | 20′-5.8438″ | .780′ | 9.360″ | 153 |
| 12 and 16 | 25′-10.7813″ | 19′-11.9688″ | .772′ | 9.2638″ | 154 |

8 in 12 Uneven Pitches - Bird's Eye Views - Hip Ridges

| | | | | | |
|---|---|---|---|---|---|
| 8 and 2 | 16′-9.3438″ | 16′-5.9063″ | .983′ | 11.7958″ | 85 |
| 8 and 3 | 17′-7.8438″ | 17′-1.0313″ | .968′ | 11.6159″ | 86 |
| 8 and 4 | 18′-9.5625″ | 17′-10.6563″ | .952′ | 11.424″ | 87 |
| 8 and 5 | 20′-1.9688″ | 18′-10.4063″ | .936′ | 11.2318″ | 88 |
| 8 and 6 | 21′-8.5313″ | 19′-11.9688″ | .921′ | 11.0519″ | 89 |
| 8 and 7 | 23′-4.8438″ | 21′-3.0938″ | .908′ | 10.8959″ | 90 |
| 8 and 9 | 24′-1.4688″ | 21′-4.8438″ | .887′ | 10.6439″ | 91 |
| 8 and 10 | 23′-3.75″ | 20′-5.8438″ | .879′ | 10.548″ | 92 |
| 8 and 11 | 22′-8.3125″ | 19′-9.375″ | .872′ | 10.4638″ | 93 |
| 8 and 12 | 22′-2.5313″ | 19′-2.7188″ | .866′ | 10.392″ | 94 |
| 8 and 13 | 21′-9.9688″ | 18′-9.4063″ | .860′ | 10.3199″ | 95 |
| 8 and 14 | 21′-6.25″ | 18′-5.125″ | .856′ | 10.2719″ | 96 |
| 8 and 15 | 21′-3.25″ | 18′-1.5938″ | .852′ | 10.2239″ | 97 |
| 8 and 16 | 21′-0.75″ | 17′-10.6563″ | .849′ | 10.188″ | 98 |

8 in 12 Uneven Pitches - Elevation Views - Hip Ridges

| | | | | | |
|---|---|---|---|---|---|
| 8 and 2 | 16′-9.3438″ | 16′-2.6563″ | .967′ | 11.6038″ | 295 |
| 8 and 3 | 17′-7.8438″ | 16′-5.9063″ | .934′ | 11.2079″ | 296 |
| 8 and 4 | 18′-9.5625″ | 16′-10.375″ | .897′ | 10.7638″ | 297 |
| 8 and 5 | 20′-1.9688″ | 17′-4.000″ | .860′ | 10.3199″ | 298 |
| 8 and 6 | 21′-8.5313″ | 17′-10.6563″ | .824′ | 9.8878″ | 299 |
| 8 and 7 | 23′-4.8438″ | 18′-6.2813″ | .791′ | 9.4919″ | 300 |
| 8 and 9 | 24′-1.4688″ | 17′-9.3438″ | .737′ | 8.844″ | 301 |
| 8 and 10 | 23′-3.75″ | 16′-7.9375″ | .715′ | 8.580″ | 302 |
| 8 and 11 | 22′-8.3125″ | 15′-9.4375″ | .696′ | 8.3519″ | 303 |
| 8 and 12 | 22′-2.5313″ | 15′-1.0313″ | .679′ | 8.1479″ | 304 |
| 8 and 13 | 21′-9.9688″ | 14′-6.1875″ | .665′ | 7.9798″ | 305 |
| 8 and 14 | 21′-6.25″ | 14′-0.5938″ | .653′ | 7.8359″ | 306 |
| 8 and 15 | 21′-3.25″ | 13′-7.9063″ | .642′ | 7.704″ | 307 |
| 8 and 16 | 21′-0.75″ | 13′-4.000″ | .633′ | 7.596″ | 308 |

12 in 12 Uneven Pitches - Elevation Views - Hip Ridges

| | | | | | |
|---|---|---|---|---|---|
| 12 and 2 | 16′-6.1563″ | 16′-2.6563″ | .982′ | 11.784″ | 351 |
| 12 and 3 | 17′-0.9375″ | 16′-5.9063″ | .966′ | 11.5918″ | 352 |
| 12 and 4 | 17′-9.9375″ | 16′-10.375″ | .946′ | 11.3519″ | 353 |
| 12 and 5 | 18′-8.8438″ | 17′-4″ | .925′ | 11.0999″ | 354 |
| 12 and 6 | 19′-9.4063″ | 17′-10.6563″ | .904′ | 10.8479″ | 355 |
| 12 and 7 | 20′-11.375″ | 18′-6.2813″ | .884′ | 10.6078″ | 356 |
| 12 and 8 | 22′-2.5313″ | 19′-2.750″ | .866′ | 10.392″ | 357 |
| 12 and 9 | 23′-6.7188″ | 20′-0″ | .849′ | 10.188″ | 358 |
| 12 and 10 | 24′-11.7188″ | 20′-9.9375″ | .834′ | 10.0079″ | 359 |
| 12 and 11 | 26′-5.4375″ | 21′-8.4688″ | .821′ | 9.8519″ | 360 |
| 12 and 13 | 27′3.5″ | 21′-9.2813″ | .798′ | 9.5758″ | 361 |
| 12 and 14 | 26′-8.8438″ | 21′-0.875″ | .788′ | 9.456″ | 362 |
| 12 and 15 | 26′-3.3438″ | 20′-5.875″ | .780′ | 9.360″ | 363 |
| 12 and 16 | 25′-10.7813″ | 20′-0″ | .772′ | 9.2638″ | 364 |

16 in 12 Uneven Pitches Elevation Views - Hip Ridges

| | | | | | |
|---|---|---|---|---|---|
| 16 and 2 | 16′-5.0313″ | 16′-2.6563″ | .988′ | 11.8558″ | 407 |
| 16 and 3 | 16′-10.4688″ | 16′-5.9063″ | .977′ | 11.7239″ | 408 |
| 16 and 4 | 17′-5.6875″ | 16′-10.375″ | .965′ | 11.580″ | 409 |
| 16 and 5 | 18-2.500″ | 17′-4″ | .952′ | 11.424″ | 410 |
| 16 and 6 | 19′-0.7500″ | 17′-10.6563″ | .938′ | 11.2559″ | 411 |
| 16 and 7 | 20′-0.2188″ | 18′-6.2813″ | .925′ | 11.0999″ | 412 |
| 16 and 8 | 21′-0.750″ | 19′-2.750″ | .913′ | 10.956″ | 413 |
| 16 and 9 | 22′-2.1875″ | 20′-0″ | .902′ | 10.8238″ | 414 |
| 16 and 10 | 23′-4.4063″ | 20′-9.9375″ | .891′ | 10.6919″ | 415 |
| 16 and 11 | 24′-7.3125″ | 21′-8.4688″ | .882′ | 10.5839″ | 416 |
| 16 and 12 | 25′-10.7813″ | 22′-7.5313″ | .874′ | 10.4879″ | 417 |
| 16 and 13 | 27′-2.750″ | 23′-7.0625″ | .866′ | 10.392″ | 418 |
| 16 and 14 | 28′-7.125″ | 24′-7.0313″ | .860′ | 10.3199″ | 419 |
| 16 and 15 | 29′-11.875″ | 25′-7.3438″ | .854′ | 10.2478″ | 420 |

1. Claim one (1) includes the digital scale with an LCD panel and menu buttons to determine material estimations to an accuracy of 0.032″

2. Claim two (2) includes all of the calculations from which the images or scale line distances have been derived for measuring the framing of a roof on residential and commercial structures at any pitch given.

3. Claim three (3) includes the conversion of architectural and engineering scales to a digital format to be displayed on the LCD panel.

4. Claim four (4) includes the software to be used within the scale.

5. Claim five (5) includes the notches that are used to determine plans that are not to scale and the method of obtaining those scales and/or notches.

6. Claim six (6) includes the sliding mechanism which is able to begin at a stationary point and ‘slide’ to a desired point to obtain an accurate measurement based upon the software input to an internal CPU.

7. Claim seven (7) This independent claim includes the ability to simply lay a device on a set of architectural plans, whether it be the roof plans or the elevations, and obtain rafter lengths and hips and valley lengths at any given roof pitch by directly using the calculations previously submitted in the original application. This method has never been used before in the measuring industry.
